(19) United States
(12) Patent Application Publication
(10) Pub. No.: US 2022/0122161 A1
(43) Pub. Date: Apr. 21, 2022

(54) INTEGRATING SHOPPING CART INTO A VIDEO

(71) Applicant: Vexpro Technologies, Inc., Palo Alto, CA (US)

(72) Inventor: Rayhan Perera, London (GB)

(21) Appl. No.: 17/146,272

(22) Filed: Jan. 11, 2021

Related U.S. Application Data
(60) Provisional application No. 63/092,835, filed on Oct. 16, 2020.

(51) Int. Cl. G06Q 30/06

(52) U.S. Cl. CPC G06Q 30/0643; G06Q 30/0623; G06Q 30/0633

(57) ABSTRACT

An interactive content system generates an interactive video by combining a video with an interactive layer that enables a user to add products into a shopping cart within the video. The interactive layer includes product information related to products presented in the video and a hotspot that allows the user to access the product information. When the interactive video is played, the interactive layer presents the hotspot in the video, which a user can select to access product information related to products presented in the video. Upon receiving user selection of the hotspot, the interactive layer presents the product information within the video. The user may then select a product from the product information and add it to a shopping cart within the video, thereby enabling the user to add products to the shopping without leaving, exiting, or being navigated away from the video, e.g., to another web site or application.

### RELATED APPLICATIONS

This application claims priority to the U.S. Provisional Application No. 63/092,835 filed Oct. 16, 2020, which is expressly incorporated herein by reference.

### TECHNICAL FIELD

The disclosed embodiments relate to interactive videos, including, interactive videos with an integrated shopping cart.

### BACKGROUND

Video is being consumed at an exponential level online. Companies use videos for marketing and advertising their products and services (collectively referred to as “products”). Some videos are interactive in nature, that is, an end user watching the video can interact with the video to perform various actions, e.g., filling a form presented in the video, clicking on a link presented in the video to be navigated to a website of a content owner, etc. Currently interactive video is defined by hyperlinks to content owners' sites where the user can perform the required transaction. For example, clicking on a link in a video that presents products of a merchant navigates the user away from the video to the merchant website where the user can search for the interested products and buy them. Such interactive videos have a drawback. For example, the video to cart is a very long journey as the user has to search for the products, browse through the search result to identify the product shown in the video and then add it to the cart, which consumes a significant amount of time leaving potential customers ample time to leave the route. These and other drawbacks exist.

### SUMMARY

Aspects of the disclosed embodiments relate to methods, apparatuses, and/or systems for interactive videos with an integrated shopping cart.

In some embodiments, an interactive content system generates an interactive video by combining a video with an interactive layer that enables a user to add products or services (collectively referred to as “products”) into a shopping cart within the video. The interactive layer includes product information related to products presented in the video and a hotspot that allows the user to access the product information, and enables the user to add one or more products to a shopping cart from the product information presented in the interactive layer. In some embodiments, the interactive video may be played using a player that is configured to combine the interactive layer with a video. When the interactive video is played by a user, the interactive layer presents the hotspot in the video, which the user can select to access product information related to products presented in the video. Upon receiving user selection of the hotspot, the interactive layer presents the product information within the video, thereby enabling the user to access the product information (e.g., for viewing additional information of the product or for buying) without leaving, exiting, or being navigated away from the video, e.g., to another website or application. The user may then select one or more products from the product information and add them to a shopping cart within the video. Such an interactive video provides a convenient way for the user to purchase a product from a video by significantly reducing a video-to-cart journey time and minimizing computing resources otherwise required to make the purchase, thereby providing an improvement over prior interactive video techniques.

After the user adds the products to the shopping cart, the user may proceed with a checkout process that may require the user to input payment information or shipping information to complete the checkout process. In some embodiments, the checkout process may cause the user device to navigate to a uniform resource locator (URL) of an online store of a merchant associated with the shopping cart to complete the checkout process.

Note that presenting content (e.g., hotspot or product information) “within” the video may mean that the content is overlaid on the video as an overlay, or the content is presented along with the video in a window (e.g., a graphical user interface (GUI) element such as a container or frame) of the player such that the content does not overlap with the video. In some embodiments, the hotspot is a GUI element, such as a button, that a user can interact with.

In some embodiments, the interactive content system provides a GUI for creating an interactive video. An entity, such as a merchant offering products for sale, may use the GUI for creating an interactive video that enables a user to buy one or more products offered for sale by the merchant from the interactive video. In some embodiments, creating the interactive video includes obtaining a video to which an interactive layer that enables a user to add products into a shopping cart within the video, configuring the interactive layer to enable the interaction with the video, and combining the video with the interactive layer. In some embodiments, configuring an interactive layer includes establishing an access to an online store of the merchant hosted at a product server, obtaining product information the from the product server, configuring product information of one or more products to be shopped from the video and configuring one or more hotspots, which provide access to the product information in the video, and generating a configuration file having the interactive layer for the video. In some embodiments, the configuration file may be downloaded to a client device, such as a computer, and played using a player that combines the video with the interactive layer. In some embodiments, the configuration file may be stored in the interactive content system and a link, e.g., an URL that identifies the location of the configuration file may be used to access the interactive video. Such an URL may be included in any webpage, e.g., a webpage associated with a publisher who publishes content, social network application, email, etc. When the URL is accessed, the player obtains the video and the interactive layer using the configuration file and combines them to play the interactive video.

The product server may provide a number of ecommerce services, including an inventory service, which manages an inventory of the products, and a shopping cart service, which manages shopping cart operations (e.g., create, read, update, and delete). Establishing the connection with the product server may enable the interactive layer to integrate the ecommerce services of the product server, such as the shopping cart service with the video. The connection between the interactive content system and the product server may be established using an application programming interface (API) associated with the product server.

Note that while the foregoing paragraphs describe the interactive videos as providing a functionality for shopping products, they are not restricted to such functionality. The interactive videos may be used for various applications, e.g., for making a donation to a charity organization directly from within a video, for subscribing to receive additional information about a topic from within a video, making changes to content in the video from within the video (e.g., changing configuration of a car in the video), etc.

Various other aspects, features, and advantages of the invention will be apparent through the detailed description and the drawings attached hereto. It is also to be understood that both the foregoing general description and the following detailed description are examples and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 shows a system for creating an interactive video, in accordance with one or more embodiments.

FIG. 2A shows a screenshot of an interactive video with a hotspot, in accordance with one or more embodiments.

FIG. 2B shows a screenshot of the interactive video presenting product information of a product, in accordance with one or more embodiments.

FIG. 2C shows a screenshot of the interactive video presenting product information of another product, in accordance with one or more embodiments.

FIG. 2D shows a screenshot of the interactive video with an updated shopping cart, in accordance with one or more embodiments.

FIG. 2E shows a screenshot of the interactive video with the shopping cart, in accordance with one or more embodiments.

FIG. 2F shows a screenshot of a checkout GUI of the interactive video, in accordance with one or more embodiments.

FIG. 3A shows a screenshot of a store integration GUI for inputting store credentials to establish access to an online store, in accordance with one or more embodiments.

FIG. 3B shows a screenshot of a GUI for importing products from product server, in accordance with one or more embodiments.

FIG. 3C shows a screenshot of a GUI for configuring the interactive layer, in accordance with one or more embodiments.

FIG. 4A shows a screenshot of a video in which hotspots are displayed in a sidebar of a player window, in accordance with one or more embodiments.

FIG. 4B is a screenshot of a video in which product information is displayed in a sidebar of a player window, in accordance with one or more embodiments.

FIG. 5 is a block diagram for accessing an interactive video, in accordance with one or more embodiments.

FIG. 6 shows a screenshot of webpage hosting an interactive video, in accordance with one or more embodiments.

FIG. 7 shows a flowchart of a method for playing an interactive video, in accordance with one or more embodiments.

FIG. 8 shows a flowchart of a method for providing interactivity in a video, in accordance with one or more embodiments.

FIG. 9 shows a flowchart of a method for generating an interactive video, in accordance with one or more embodiments.

FIG. 10A shows a screenshot of an interactive video for making a donation, in accordance with one or more embodiments.

FIG. 10B shows a screenshot of an interactive video with donation payment information, in accordance with one or more embodiments.

FIG. 11A shows a screenshot of an interactive video made for a smartphone, in accordance with one or more embodiments.

FIG. 11B shows a screenshot of an interactive video with a hotspot, in accordance with one or more embodiments.

FIG. 11C shows a screenshot of an interactive video with product information, in accordance with one or more embodiments.

FIG. 11D shows a screenshot of an interactive video with shopping cart details, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

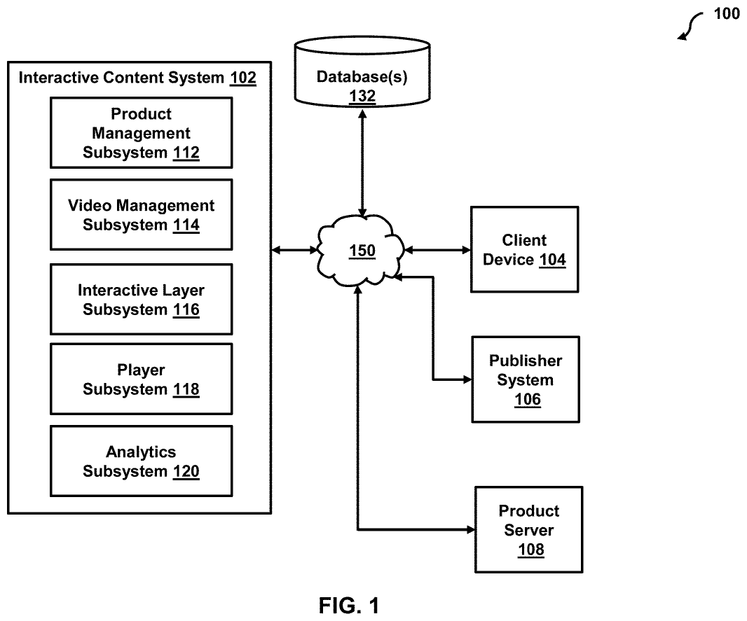

FIG. 1 shows a system 100 for creating an interactive video, in accordance with one or more embodiments. As shown in FIG. 1, system 100 may include interactive content system 102, client device 104, publisher system 106, product server 108, database 132, or other components. Interactive content system 102 may include product management subsystem 112, video management subsystem 114, interactive layer subsystem 116, player subsystem 118, analytics subsystem 120, or other components. By the way of example, interactive content system 102 may include a distributed system, a cloud-based system, a container environment on one or more servers, or other systems.

Publisher system 106 may include one or more servers that publishes content, which may be accessed by users via a website, an app or email associated with publisher system 106. For example, publisher system 106 may be a server that publishes fashion content, home decor, news, movies, tv shows, educational courses, charity, etc.

Product server 108 may include one or more servers that provides ecommerce services for hosting an online store, which offers products for sale. An entity, such as a merchant, may have an online store that may consume ecommerce services offered by the product server 108, including inventory management, shopping cart, payments, marketing, shipping, or customer engagement services for running the online store. The merchant may have to establish an account with product server 108 to consume the services provided by product server 108. By way of an example, product server 108 may include an ecommerce solution provider such as Shopify Inc. of Ontario, Canada. In some embodiments, product server 108 may include one or more servers that host an online store associated with a merchant.

Client device 104 may include any type of mobile terminal, fixed terminal, or other device. By the way of example, client device 104 may include any computing device, such as a personal computer (PC), a laptop computer, a tablet computer, a hand-held computer, other computer equipment. Users may, for instance, utilize client device 104 to interact with one or more components of system 100.

A component of system 100 may communicate with one or more components of system 100 via communication network 150 (e.g., Internet, a mobile phone network, a mobile voice or data network, a cable network, a public switched telephone network, or other types of communications networks or combinations of communications networks). The communication network 150 may be a wireless or wired network.

It should be noted that, while one or more operations are described herein as being performed by particular components of system 100, those operations may, in some embodiments, be performed by other components of system 100. As an example, while one or more operations are described herein as being performed by components of interactive content system 102, those operations may, in some embodiments, be performed by components of client device 104.

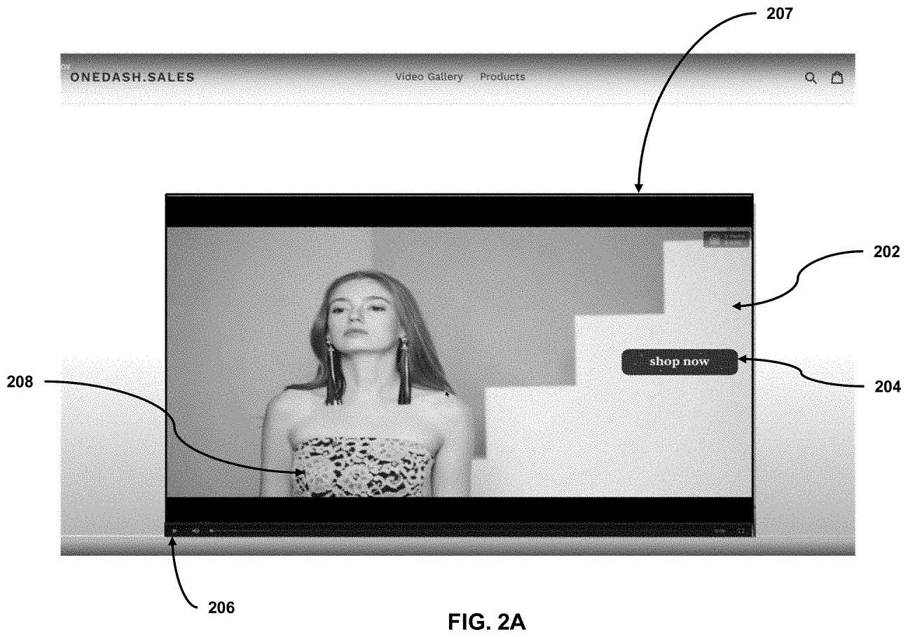

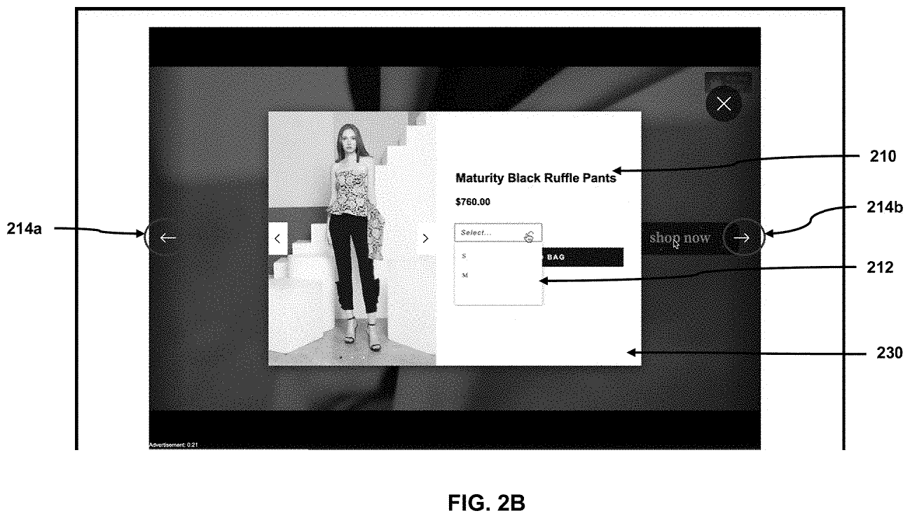

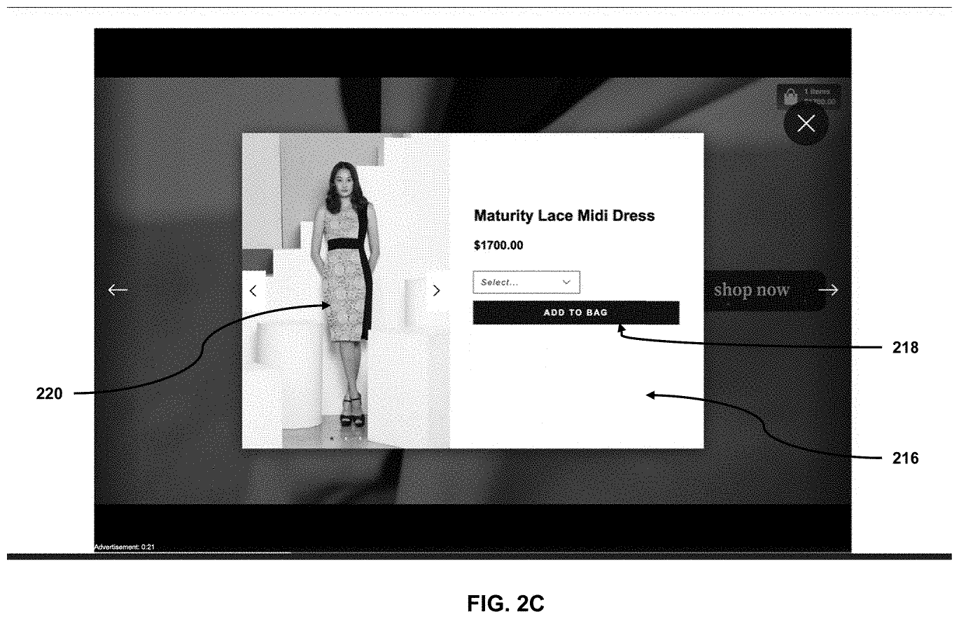

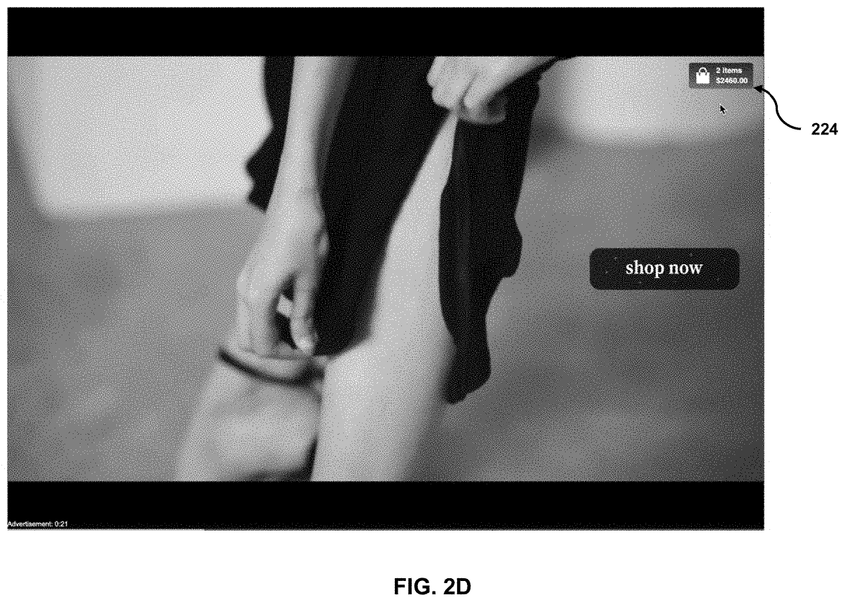

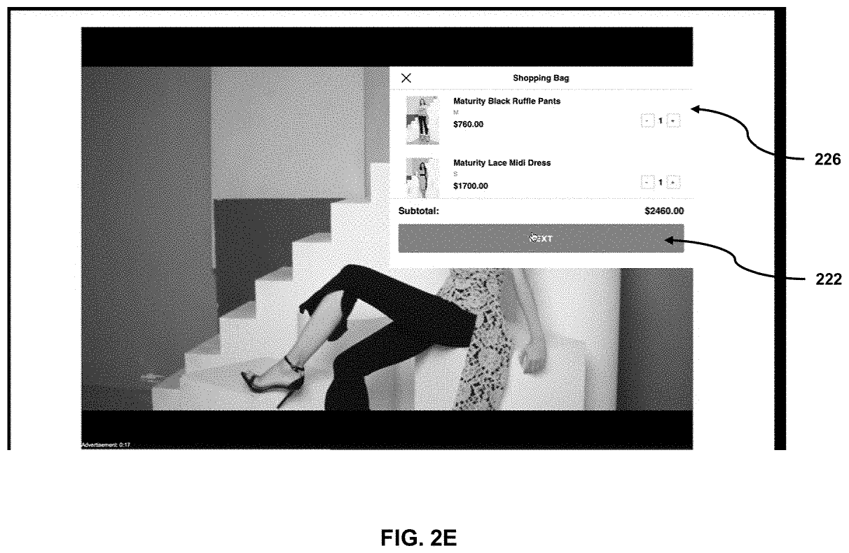

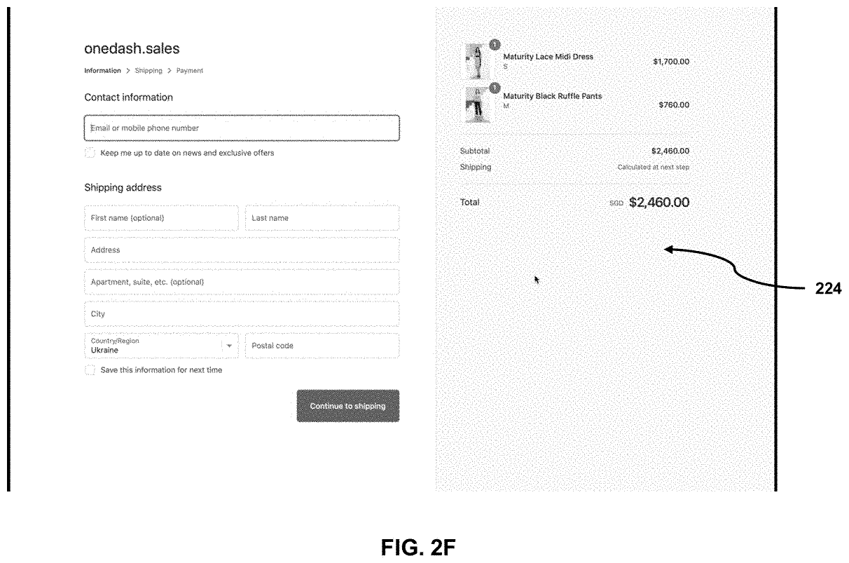

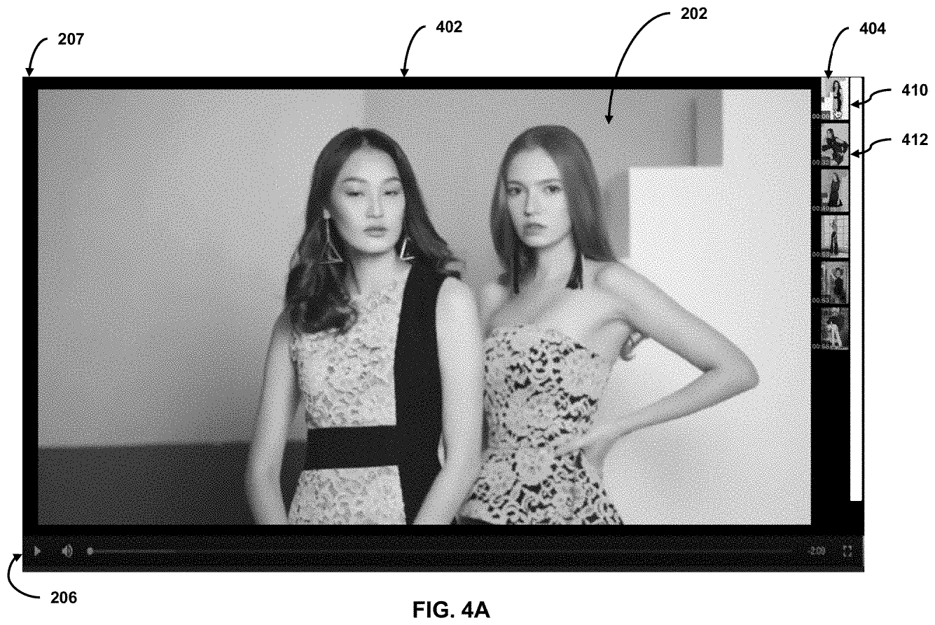

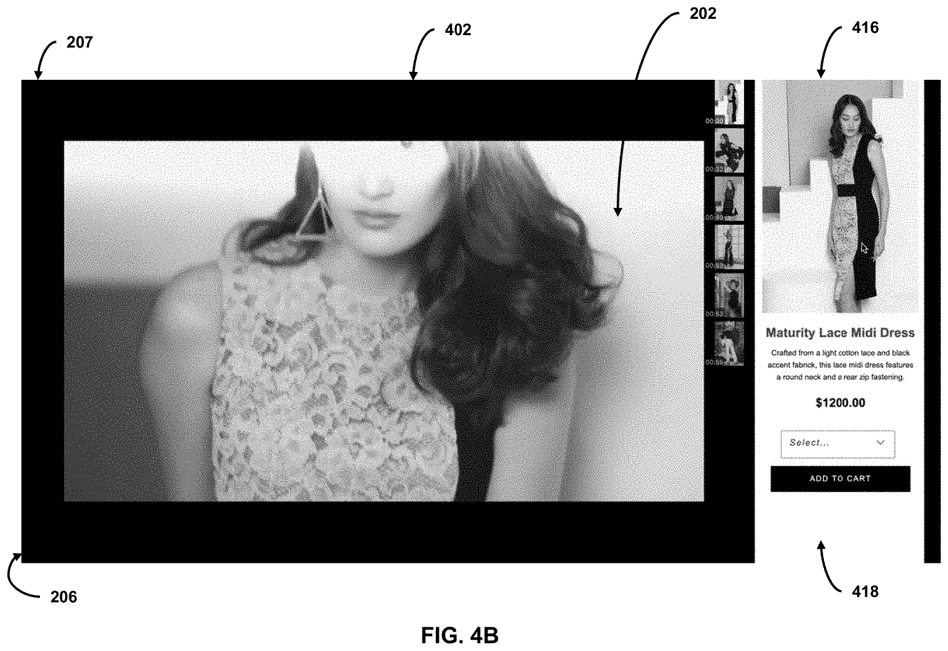

In some embodiments, an interactive video enables a user to perform various interactions with content presented in a video, such as adding products presented in the video to a shopping cart from within the video. FIGS. 2A-2F show various screenshots of an interactive video, in accordance with one or more embodiments. In some embodiments, the interactive video is generated using interactive content system 102 of FIG. 1, the details of which are described later. FIG. 2A shows a screenshot of an interactive video with a hotspot, in accordance with one or more embodiments. The interactive video includes hotspot 204 that allows the user to access product information related to content, such as product 208 (e.g., a woman's top), presented in video 202. The hotspot 204 may be presented in video 202 in a number of ways. For example, hotspot 204 may be overlaid on video 202. In another example, the hotspot may be presented in video 202 such that it does not overlap with video 202 (which is described at least with reference to FIG. 4A). In some embodiments, the interactive video is played using a player 206 that provides interactive capabilities to video 202 by combining an interactive layer (which is described in detail below) with video 202. The player 206 plays video 202 within a player window 207, which as described above is a GUI element such as a container or a frame.

FIG. 2B shows a screenshot of the interactive video presenting product information of a product, in accordance with one or more embodiments. The interactive video presents product information 210 related to content, such as product 208 (e.g., a woman's top) presented in video 202, in response to user selection of hotspot 204. The product information 210 may include product data, such as an image of the product 208, or one or more attributes of the product 208, e.g., size, color, price, or other attribute of product 208. The product information 210 may be presented in video 202 in a number of ways. For example, product information 210 may be overlaid on video 202 as an overlay 230. In another example, product information 210 may be presented in video 202 such that it does not overlap with video 202 (e.g., illustrated at least with reference to FIG. 4B). The user may perform a number of actions from product information 210. For example, the product information 210 may allow the user to select an attribute 212 of product 208, e.g., a size, a color, or other attributes of the product. In another example, the user may also access product information of other products, e.g., using GUI elements 214a or 214b, available for selection by the user. In another example, the user may close the overlay 230, in which case the video 202 may resume playing. In another example, the user may add the product to the shopping cart from the overlay 230. In some embodiments, the product information 210 presented in the interactive video may correspond to a product that is being shown in video 202 at the time hotspot 204 was selected by the user. In some embodiments, the product information 210 presented in the interactive video may be of any product presented in video 202 regardless when hotspot 204 was selected by the user. In some embodiments, the product information 210 presented in the interactive video may not correspond to any product presented in video 202.

FIG. 2C shows a screenshot of the interactive video presenting product information 216 of another product 220, in accordance with one or more embodiments. In some embodiments, the product information 216 may be presented upon user selection of GUI elements 214a or 214b from product information 210. The user may add a product, e.g., product 220, to a shopping cart integrated in video 202. For example, the user may add the product 220 to the shopping cart using GUI element 218 from product information 216. That is, the user may add a product to the shopping cart without leaving, exiting, or otherwise being navigated away (e.g., to another website or application) from video 202. Such an interactive video provides a convenient way to purchase a product from a video by significantly reducing a video-to-cart journey time for the user and minimizing computing resources otherwise required to make the purchase, thereby providing an improvement over prior interactive video techniques.

FIG. 2D shows a screenshot of the interactive video with an updated shopping cart, in accordance with one or more embodiments. The interactive video includes a cart GUI element 224 that corresponds to a shopping cart integrated into video 202. The cart GUI element 224 may also indicate a number of products added to the shopping cart.

FIG. 2E shows a screenshot of the interactive video with the shopping cart, in accordance with one or more embodiments. The interactive video allows the user to access shopping cart 226 to view or edit a list of products 220 added to shopping cart 226. In some embodiments, the list of products in shopping cart 226 may be overlaid on video 202. The user may proceed to checkout process from the shopping cart 226, e.g., using GUI element 222.

FIG. 2F shows a screenshot of a checkout GUI of the interactive video, in accordance with one or more embodiments. In some embodiments, a checkout process, which includes inputting payment or shipping information and completing a transaction, is performed outside of the interactive video, e.g., in a webpage associated with an online store of the merchant. The checkout GUI 224 corresponds to a checkout webpage associated with the online store of the merchant.

The interactive video provides various interactions, such as the ones discussed at least with reference to FIGS. 2A-2F, (e.g., presenting a hotspot in the video, presenting product information in the video, enabling a user to add a product to shopping cart), through an interactive layer that is combined with video 202. Referring to FIG. 1, interactive content system 102 facilitates the creation of the interactive layer. In some embodiments, an entity, such as a merchant, may create an interactive video, such as the one described at least with reference to FIGS. 2A-2F, using interactive content system 102. In some embodiments, creating the interactive video includes establishing a connection between interactive content system 102 and product server 108 associated with an online store of the merchant, obtaining the video to which an interactive layer is to be added, obtaining product information the from the product server, configuring the interactive layer, and generating a configuration file having the interactive layer for the video (all of which are described in detail in the following paragraphs). The interactive content system 102 may provide a number of GUIs that aids in the creation of the interactive video.

### Subsystems 112-124

In some embodiments, product management subsystem 112 facilitates integration of an online store of a merchant with interactive content system 102. The product management subsystem 112 manages various communications between product server 108 and interactive content system 102. For example, product management subsystem 112 may facilitate functionalities such as establishing access to an online store of a merchant on product server 108, obtaining product information of products from product server 108, obtaining product updates in real-time (e.g., at a time when a user adds a product to the shopping cart in the interactive video), or other functionalities. The product management subsystem 112 may establish access to the online store via an API provided by product server 108. In some embodiments, the API may require store credentials to access the online store at product server 108.

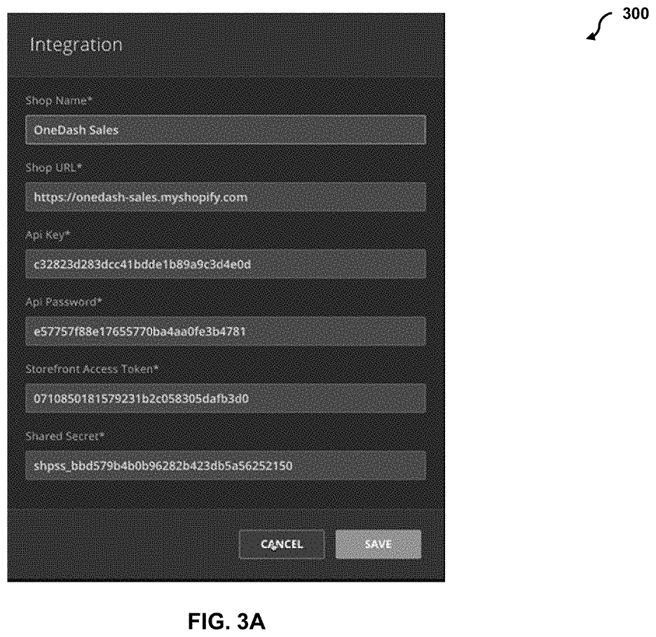

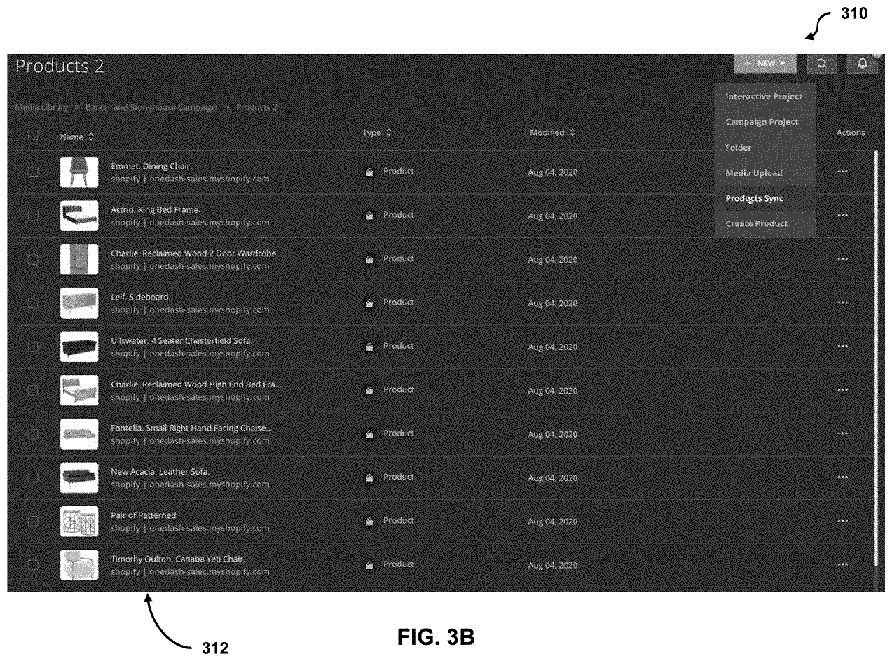

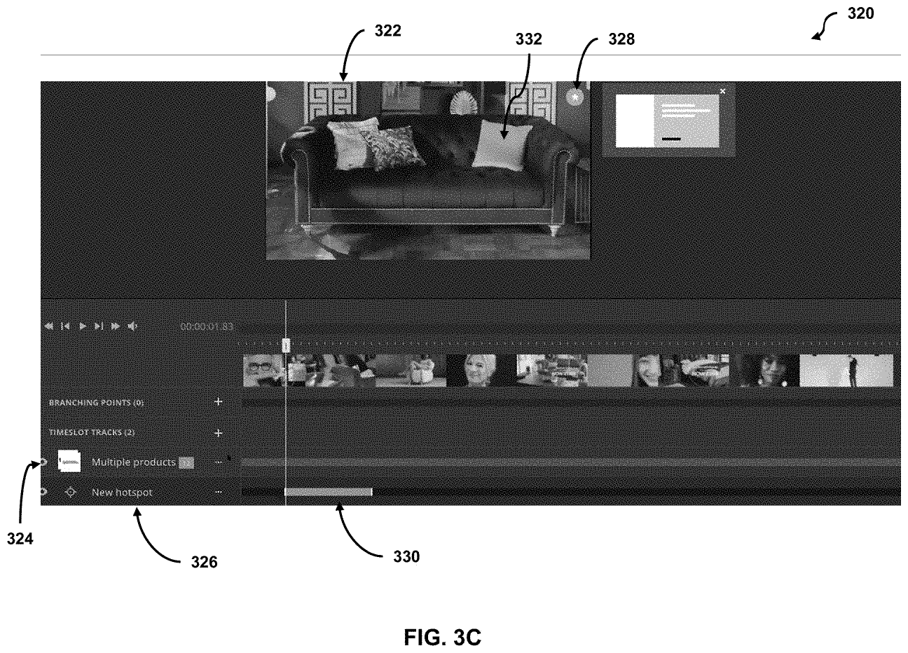

FIG. 3A shows a screenshot of a store integration GUI for inputting store credentials to establish access to the online store, in accordance with one or more embodiments. The API may require store credentials such as “Shop Name,” “Shop URL,” “API Key,” “API Password,” “Storefront Access Token,” “Shared Secret,” or other credentials as shown in store integration GUI 300. In some embodiments, the “Shop Name” attribute identifies a name of the online store and the “Shop URL” attribute identifies an URL of the online store at product server 108. In some embodiments, the “API Key” attribute “API Password” identify access credential such as username and password required to access the online store. In some embodiments, “Storefront Access Token,” attribute identifies a token required to access “Storefront API,” which provides various services such as reading or modifying products, customer data, shopping cart, etc. In some embodiments, the “Shared Secret” attribute is used as proof of identity for authentication of interactive content system 102 with product server 108. While the store integration GUI 300 shows the foregoing store credentials as required by the API to establish access with the online store of the merchant at product server 108, the store credentials required to access the online is not restricted to the foregoing attributes as, in some embodiments, different types of online stores may require different credentials. The credentials required may be some of the foregoing attributes, or attributes different from the foregoing attributes. For example, some online stores may require credentials such as an account number of the online at product server 108 and an URL of the online store to access the online store.

In some embodiments, product management subsystem 112 facilitates importing of product information from the online store of the merchant at product server 108 to interactive content system 102. As described above, the product information may include product data, such as an image of a product, one or more attributes of the product, e.g., size, color, price, or other attribute of product. The imported product information may then be used for presentation with an interactive video.

FIG. 3B shows a screenshot of a GUI for importing products from product server 108, in accordance with one or more embodiments. After establishing access to the online store as described above at least with reference to FIG. 3A, the product information of one or more products may be obtained using the GUI 310, e.g., by selecting “Products Sync” option, which imports product information of one or more products from product server 108. The GUI 310 also shows a list of products 312 imported from product server 108. In some embodiments, the product information is imported prior to creating the interactive video. Further, in some embodiments, if product information of a product changes at product server 108 after importing, performing a synchronization, e.g., by selecting “Products Sync” option, updates the product information at interactive content system 102 with the product information at product server 108. In yet other embodiments, the product information may be synchronized automatically, that is, whenever product information changes at product server 108, the corresponding product information is automatically updated at interactive content system 102. While product information may be imported from product server 108, in some embodiments, product information may be generated at interactive content system 102. For example, product management subsystem 112 may provide a product creator tool (e.g., to create an image, add product data, etc.), which the merchant user may use to create the product information. In some embodiments, the product information imported from product server 108 is stored in database 132.

In some embodiments, video management subsystem 114 facilitates management of a video that is to be presented to the user. The video may include content associated with a set of products of the merchant. The merchant may upload a video, such as video 202, to interactive content system 102, e.g., using “Media Upload” option in the GUI 310. The video management subsystem 114 allows the user to upload the video from a computing device associated with the merchant or from a cloud-based storage service. In some embodiments, video management subsystem 114 may also provide a video editor tool, which may be used for creating the video in interactive content system 102. The video management subsystem 114 may support videos of a number of formats, e.g., MOV, MP4, MKV, FLV, SWF, or other formats. In some embodiments, video management subsystem 114 may convert the uploaded video to a format suitable for combining the interactive layer with the video.

In some embodiments, interactive layer subsystem 116 may facilitate creation or configuration of the interactive layer. As described above, the interactive layer includes product information that is to be presented within the video and a hotspot that allows the user to access the product information in the video. The interactive layer may also enable a user to add one or more products to a shopping cart within the video.

The interactive layer subsystem 116 may provide a GUI to configure the interactive layer. FIG. 3C shows a screenshot of GUI 320 for configuring the interactive layer, in accordance with one or more embodiments. The merchant user may select video 322 for which the interactive layer is to be configured. In some embodiments, video 322 has content related to a set of products the merchant has to offer for sale. The video 322 may be uploaded to, or created using, interactive content system 102 as described at least with reference to video management subsystem 114. In some embodiments, video 322 is similar to video 202 of FIG. 2A. The merchant user may then add product information 324 of the set of products to the interactive layer. In some embodiments, the set of products may be products that are shown in video 322. The set of products may be added to the interactive layer manually (e.g., by merchant user creating the interactive layer) or automatically by interactive content system 102. For example, the set of products may be selected from the list of products 312 imported from product server 108 (described at least with reference to FIG. 3B). In another example, the set of products may be identified automatically from video 322 using various techniques, e.g., artificial intelligence techniques. The video management subsystem 114 may analyze video 322 to obtain feature vectors representative of the products in video 322. The feature vectors representative of the products may then be compared to reference feature vectors representative of reference products stored in database 132 (e.g., list of products 312). The reference products whose reference feature vectors match the feature vectors of the products from video 322 may be identified as the set of products. In the example of FIG. 3C, product information 324 of twelve products is added to the interactive layer. In some embodiments, when video 322 is played, product information 324 may be presented in video 322 in a way similar to product information 210 and 216 of FIGS. 2A-2C, e.g., as an overlay on the video 322.

One or more hotspots, such as hotspot 328, may be added to the interactive layer. In some embodiments, hotspot 328 is a GUI element, such as a button, image, or any other GUI element, that a user can interact with for performing a specified action in video 322. For example, the hotspot 328 may be configured to present product information 324 in video 322 when video 322 is being played upon user selection (e.g., clicked, tapped, or selected otherwise) of hotspot 328.

The hotspot 328 may be configured to present product information of a specified product or multiple products of the products added to the interactive layer. In some embodiments, the hotspot 328 may be configured to present product information corresponding to a product being shown in video 322 at the time when user selected the hotspot 326. For example, if the user selects hotspot 328 at a time of one minute and ten seconds into video 322 and a chair was being shown in video 322 during that time, then product information of the chair is presented in video 322. In another example, the product information of products other than the product being shown in video 322 may be presented as well (e.g., user may scroll through product information as described at least with reference to FIGS. 2B and 2C.

Further, in some embodiments, hotspot 328 may configured to appear in video 322 only at certain times, e.g., when a certain product is being presented in video 322. The timeslot, such as timeslot 330, during which hotspot 328 is to be presented in video 322 may be configured. The timeslot 330 may specify a start time and end time of the appearance of hotspot 328 in video 322. For example, timeslot 330 may specify the start time as “30 seconds” and end time as “45 seconds,” which configures the hotspot 328 to be presented from 30 seconds into video 322 until 45 seconds of video 322. In another example, hotspot 328 may be configured to be presented for the entire duration of video 322.

In some embodiments, a portion of content in video 322 may be configured as a hotspot, such as hotspot 332. For example, a cushion shown in video 322 may be configured as the hotspot 328, which may be configured to present product information of the cushion upon user selection of the hotspot 328. The video management subsystem 114 may use image recognition techniques to identify various items in video 322, which may then be configured as hotspots.

The hotspots may be configured to be presented in video 322 in a number of ways. For example, hotspot 328 may be configured to be presented as an overlay on video 322, that is, the hotspot 328 is overlaid on video 322 like hotspot 204 is overlaid on video 202 in FIG. 2A. In another example, the hotspot 328 may be presented in video 322 such that it does not overlap with video 322, like hotspots 410 and 412 illustrated in FIG. 4A. FIG. 4A shows a screenshot of a video in which hotspots are displayed in a sidebar of a player window, in accordance with one or more embodiments. As described above, the video may be played using player 206 and the player 206 plays the video within player window 207. The player window 207 may be a multilayout window in which different portions of the player window 207 present different content. For example, a first portion 402 of the player window 207 may be configured to present video 202, and a second potion 404 may be configured to display one or more hotspots, such as first hotspot 410 and second hotspot 412. The hotspots 410 and 412 may correspond to specific products being presented in video 202. For example, first hotspot 410 may correspond to product information of a first product and second hotspot 412 may correspond to product information of a second product. In some embodiments, the hotspots may indicate a time in video 202 at which the corresponding product may appear in video 202.

Like the hotspots, the product information 324 may also be configured to be presented in video 322 in a number of ways. For example, product information 324 may be presented in video 322 such that it does not overlap with video 322 in a way similar to product information 210 and 216 of FIGS. 2A-2C, e.g., as an overlay on the video 322. In another example, product information 324 may be presented in video 322 such that it does not overlap with video 322, e.g., in a way similar to product information 418 of FIG. 4B. FIG. 4B is a screenshot of a video in which product information is displayed in a sidebar of a player window, in accordance with one or more embodiments. In the example of FIG. 4B, product information 418 is presented in a third portion 416 of player window 207. In some embodiments, product information 418 is presented in response to user selection of first hotspot 410 of FIG. 4A. Note that when product information 418 is presented the dimensions (e.g., size) of the first portion 402 of player window 207 may be reduced, which also results in a reduction of the size of video 202, in order to accommodate presentation of product information 418 in third portion 416.

The interactive layer subsystem 116 facilitates various such configurations of the interactive layer, including obtaining a video (e.g., video 322) having content related to a set of products that is offered for sale by a merchant, establishing an access to the online store of the merchant at product server 108, obtaining product information from product server 108, configuring product information 324 to be presented within the video, and configuring one or more hotspots (e.g.. hotspot 328) for providing access to the product information. After the interactive layer is configured, interactive layer subsystem 116 may generate a configuration file that contains information regarding the interactive layer to be combined with the video. The configuration file may be used to play the interactive video file, e.g., using a player such as player 206. The configuration file may be accessed in various ways. In some embodiments, the configuration file may be stored at interactive content system 102, e.g., in database 132, and a link, e.g., an URL, identifying the location of the configuration file may be published to various sources. In some embodiments, the configuration file may be downloaded to client device 104, such as a computer, and played using a player installed on client device 104, which combines the video with the interactive layer to generate an interactive video. The configuration file may also include the video with which the interactive layer is to be combined, for example, for being used offline.

In some embodiments, player subsystem 118 includes a player, such as player 206, that facilitates combining the interactive layer with the video to generate an interactive video. The player 206 obtains the configuration file and combines the interactive layer as defined in the configuration file with the video. For example, when a video, such as video 202, is played, player 206 obtains the interactive layer configuration information, such as (a) access to the online store of merchant at product server 108, (b) hotspot 204, (c) product information, such as product information 210 and 216, (d) access to shopping cart services at product server 108, or other such information, and combines the interactive layer with video 202 to provide interactivity in video 202, as described at least with reference to FIGS. 2A-2F. That is, when video 202 is played, player 206 may present hotspot 204 as an overlay on the video, which the user may select to access product information within the video. Upon receiving a user selection of the hotspot 204, player 206 presents product information 210 within video 202, e.g., as an overlay. Further, the user may add one or more products to shopping cart 226 from within video 202, e.g., from the product information 210. That is, the user may access the product information or add a product to the shopping cart without leaving, exiting, or otherwise being navigated away (e.g., to another website or application) from video 202.

Additionally, player subsystem 118 communicates with product server 108, e.g., using an API associated with product server 108, to obtain real-time updates about products added to shopping cart 226. For example, when the user adds a specified product (e.g., corresponding to product information 216) to shopping cart 226, player 206 verifies with the online store at product server 108 whether the specified product is available, and adds the specified product to shopping cart 226 upon receiving a confirmation that the specified product is in stock. If the specified product is not available, player 206 may not let the user add the specified product to shopping cart 226, remove the specified product from shopping cart 226, or present a notification to the user that the specified product is not available. In some embodiments, if a specified product is not available, player 206 may not even present the product information of the specified product within video 202. Further, player 206 may verify information other than the availability of the specified product, such as price, available discounts, shipping availability, or perform some other operation associated with the specified product so that any changes to product information in product server 108 is reflected in shopping cart 226 in real-time.

In some embodiments, analytics subsystem 120 facilitates generation of various analytics. For example, analytics subsystem 120 may determine user engagement analytics such as a number of times a video has been viewed, number of drop offs (e.g., incomplete views), number of users who interacted with the video, number of interactions, or number of views that have converted to a sale. The analytics subsystem 120 may also determine interaction data regarding each interactive element in the video, such as a number of interactions with a specified hotspot or product. The analytics subsystem 120 may also determine product metrics, such as the type of products added to cart or purchased, number of products added to cart or purchased, etc., revenue generated via the interactive video. In some embodiments, the analytics subsystem 120 may be able to categorize many metrics by types of client devices (e.g., desktop, tablet, smartphone, or other types) used to view the videos. In some embodiments, the analytics subsystem 120 may be able to categorize many metrics by geographical regions (e.g., continent, country, state, city, zip code, etc.). In some embodiments, player 206 may send shopping cart data (e.g., data regarding products added to, or removed from, shopping cart) to analytics subsystem 120. In some embodiments, product server 108 may send product data (e.g., data regarding products bought by users via the video) to analytics subsystem 120.

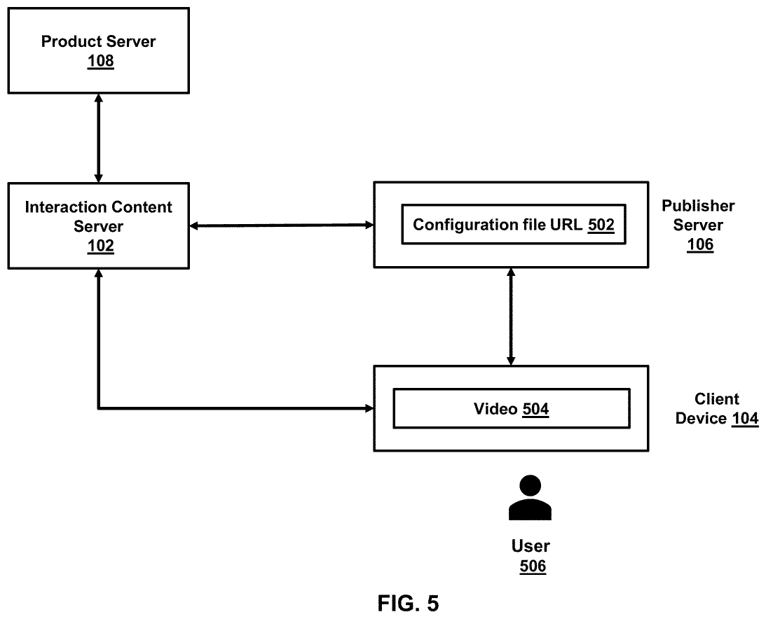

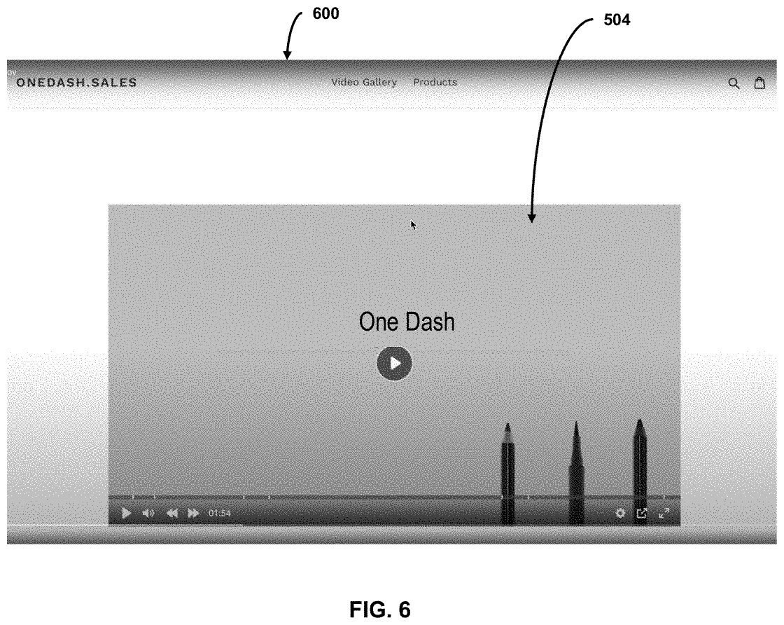

FIG. 5 is a block diagram for accessing an interactive video, in accordance with one or more embodiments. The interactive video may be accessed in a number of ways. For example, a configuration file that contains information regarding the interactive layer to be combined with the video may be downloaded to client device 104, such as a computer, and played using a player installed on client device 104, which combines the video with the interactive layer to generate an interactive video. In another example, the interactive videos may be published in websites or apps, such as social networking apps. The website may be associated with a merchant who is offering the products for sale via the interactive videos, or may be associated with a publisher, e.g., a third-party entity that publishes content associated with the publisher but also presents content from other entities, such as the merchant. The interactive video may be hosted in a website by including an URL 502 of the configuration file in a webpage. FIG. 6 shows a screenshot of webpage 600 hosting an interactive video 504, in accordance with one or more embodiments. In some embodiments, the webpage 600 is associated with a merchant that is offering products presented in the interactive video 504 for sale. The webpage 600 may include the URL 502 of the configuration file.

A user 506 may accesses the webpage 600 hosted at publisher system 106 using client device 104. When webpage 600 is rendered on client device 104, a request for the configuration file is sent to a system identified by the URL 502, which may interactive content system 102. The interactive content system 102 sends the configuration file and video 504 to client device 104. A player, such as player 206, combines the interactive layer with video 504 to play the video 504 in client device 104 providing interactivity, e.g., as described at least with reference to FIGS. 2A-2F above.

### Example Flowcharts

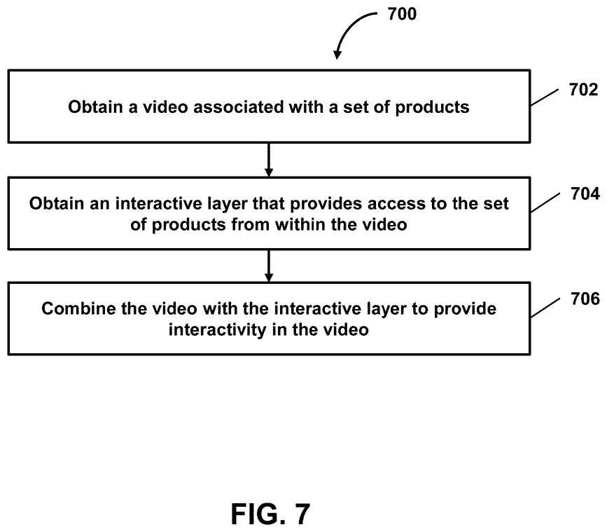

FIGS. 7-9 are example flowcharts of processing operations of methods that enable the various features and functionality of the system as described in detail above. The processing operations of each method presented below are intended to be illustrative and non-limiting. In some embodiments, for example, the methods may be accomplished with one or more additional operations not described, and/or without one or more of the operations discussed. Additionally, the order in which the processing operations of the methods are illustrated (and described below) is not intended to be limiting.

In some embodiments, the methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

FIG. 7 shows a flowchart of a method 700 for playing an interactive video, in accordance with one or more embodiments. In an operation 702, a video, such as video 202, to which user interactivity is to be provided is obtained. In some embodiments, the video may have content regarding a set of products offered for sale by a merchant. In some embodiments, the video is obtained by accessing an URL (e.g., configuration URL 502) of a configuration file associated with the video. The URL may be included or published in a website or app. In some embodiments, the configuration file is hosted in interactive content system 102.

In an operation 704, an interactive layer that provides in-video access to product information related to the set of products presented in the video is obtained. In some embodiments, the interactive layer is obtained using the URL (e.g., configuration URL 502) of the configuration file associated with the video. As described above, in some embodiments, the interactive layer includes information, such as (a) access to the online store of merchant at product server 108, (b) hotspot 204, (c) product information, such as product information 210 and 216, (d) access to shopping cart services at product server 108, or other such information.

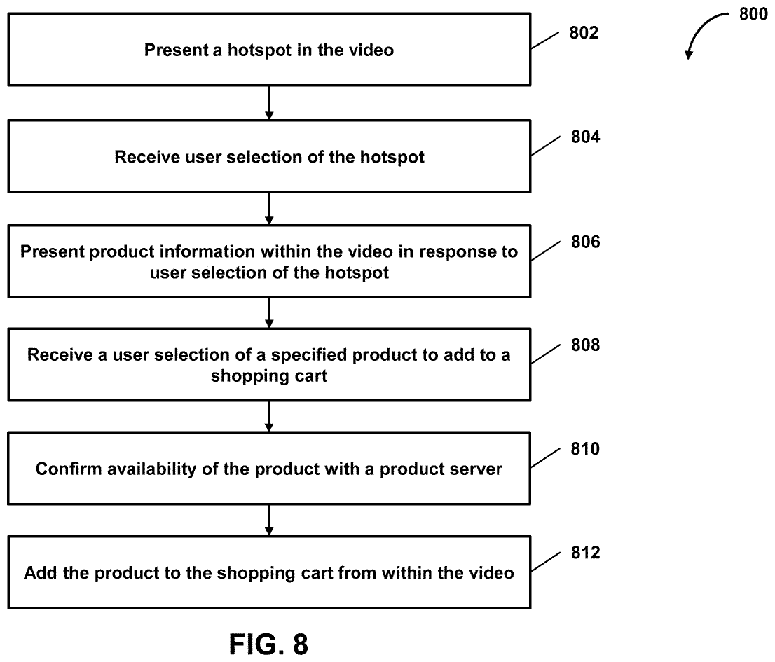

In an operation 706, the video 202 and the interactive layer are combined to provide interactivity in video 202, as described at least with reference to FIGS. 2A-2F and FIG. 8 below.

Operations 702-706 may be performed by a system that is the same as or similar to player subsystem 118, in accordance with one or more embodiments.

FIG. 8 shows a flowchart of a method 800 for providing interactivity in a video, in accordance with one or more embodiments. In some embodiments, the method 800 may be implemented as part of operation 706 of method 700. In operation 802, a hotspot is presented in the video. In some embodiments, a hotspot is a GUI element that when interacted with performs an action. The hotspot may be presented in the video in a number of ways. For example, hotspot 204 is presented as an overlay on video 202.

In an operation 804, a user selection of the hotspot is received. For example, user 506 may click, tap, or otherwise select hotspot 204.

In an operation 806, product information related to one or more products is presented within the video in response to user selection of the hotspot. The product information may include information such as an image, name, price, size, configuration, or other attribute information of a product being shown in the video. The product information may be presented in the video in a number of ways. For example, product information 210 is presented as an overlay on video 202. The user may access the product information without leaving, exiting, or otherwise being navigated away (e.g., to another website or application) from video 202.

In an operation 808, a user selection of a specified product is received. For example, user 506 may click, tap, or otherwise select the product, e.g., from product information 210, to add the corresponding product to a shopping cart integrated into the video. That is, the user may add a product to the shopping cart without leaving, exiting, or otherwise being navigated away (e.g., to another website or application) from video 202.

In an operation 810, a verification request is sent to a product server to verify product information of the specified product. In some embodiments, information such as availability of the specified product in the online store at product server 108 is verified. In some embodiments, information such as price of the specified product, offers available for the specified product or other information is verified with the online store at product server 108 in real-time to ensure that any changes to product information in the online store is updated in the shopping cart.

In an operation 812, the specified product is added to the shopping cart in response to receiving confirmation from the online store that the specified product is available. The user 506 may then proceed with the checkout process to complete the purchase.

Operations 802-812 may be performed by a subsystem that is the same as or similar to player subsystem 118, in accordance with one or more embodiments.

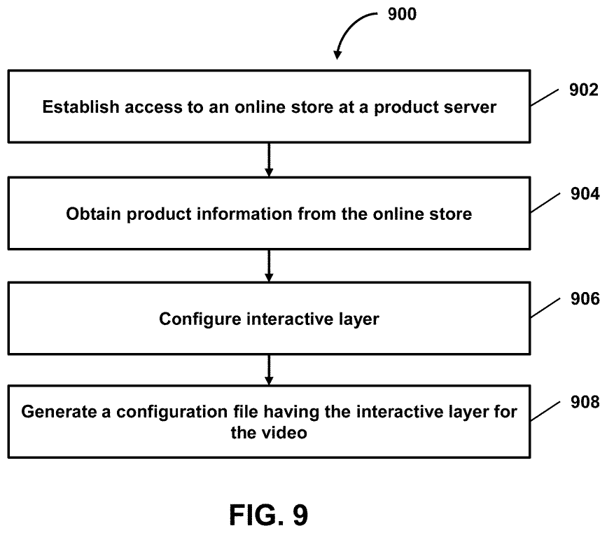

FIG. 9 shows a flowchart of a method 900 for generating an interactive video, in accordance with one or more embodiments. In operation 902, access to an online store of a merchant on product server 108 is established. In some embodiments, the access to the online store may be established via an API provided by product server 108. In some embodiments, the API may require store credentials to access the online store, such as “Shop Name,” “Shop URL,” “API Key,” “API Password,” “Storefront Access Token,” “Shared Secret” (as shown in store integration GUI 300), or other credentials.

Operation 902 may be performed by a system that is the same as or similar to product management subsystem 112, in accordance with one or more embodiments.

In an operation 904, interactive content system 102 may be synchronized with the online store to import product information from product server 108 (e.g., as illustrated in FIG. 3B). As described above, the product information may include product data, such as an image of a product, one or more attributes of the product, e.g., size, color, price, or other attribute of product. The product information that is imported is of those products that may be offered for sale via one or more interactive videos. As an example, product information for a list of products 312 may be imported from product server 108.

Operation 904 may be performed by a system that is the same as or similar to product management subsystem 112, in accordance with one or more embodiments.

In an operation 906, the interactive layer is configured. In some embodiments, configuring the interactive layer includes selecting video for which the interactive layer is to be configured, defining product information that is to be presented within the video and defining one or more hotspots to be presented in the video for allowing the user to access the product information in the video. For example, a video, such as video 322, for which the interactive layer is to be configured may be selected. The product information, such as product information 324, to be presented in the video may be added to the interactive layer. In some embodiments, product information 324 may correspond to a subset of products imported in operation 904. One or more hotspots, such as hotspot 328, may be added to the interactive layer. In some embodiments, hotspot 328 is a GUI element, such as a button, image, or any other GUI element, that a user can interact with for performing a specified action in video 322. For example, the hotspot 328 may be configured to present product information 324 in video 322 when the user selects (e.g., clicks, taps, or otherwise selects) hotspot 328.

Operation 906 may be performed by a system that is the same as or similar to video management subsystem 114 or interactive layer subsystem 116, in accordance with one or more embodiments.

In an operation 908, a configuration file is generated for the interactive layer. The configuration file may store the interactive layer details configured for the video. In some embodiments, the interactive video is played using the configuration file, e.g., as described at least with reference to method 700.

Operation 908 may be performed by a system that is the same as or similar to interactive layer subsystem 116, in accordance with one or more embodiments.

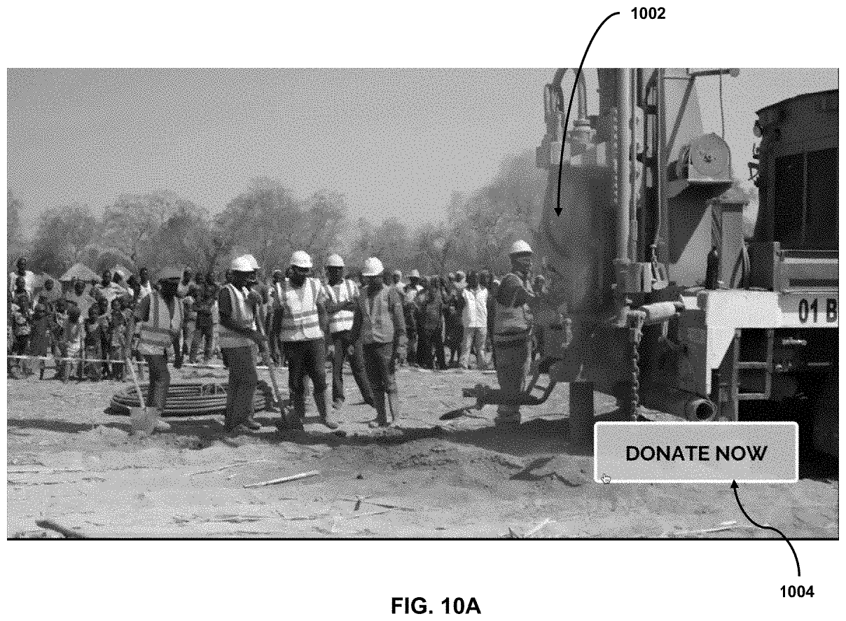

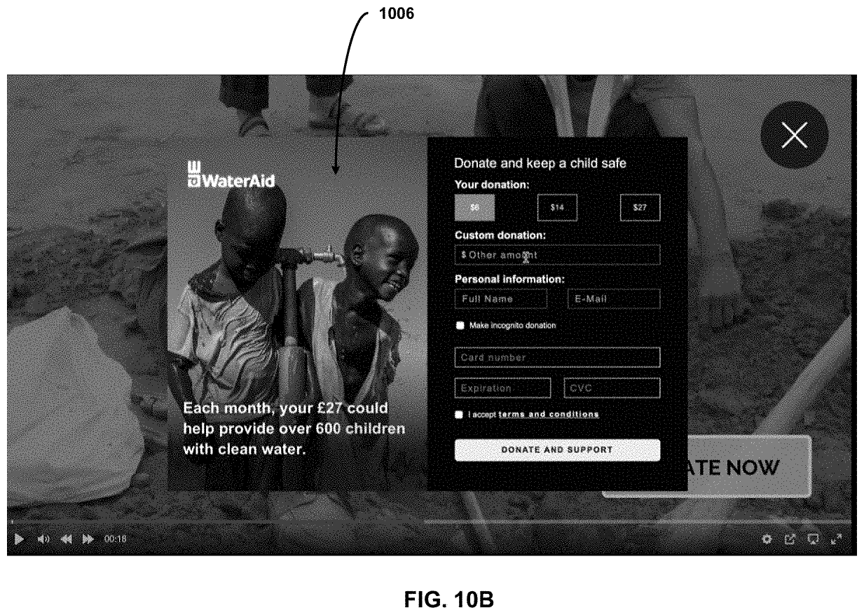

While the foregoing description focused on interactive videos for shopping, interactive videos may be used for other applications as well. FIGS. 10A and 10B show a screenshot of an interactive video for making a donation, in accordance with one or more embodiments. In some embodiments, video 1002 shows content corresponding to a charity program. User may choose to make a donation directly from video 1002 by selecting hotspot 1004. As illustrated in FIG. 10B, upon selecting the hotspot 1004 the user is presented with a payment overlay 1006 in which the user may input payment details and make the donation. That is, the user may make the donation without leaving, exiting, or otherwise being navigated away (e.g., to another website or application) from video 1002. Such an interactive video provides a convenient way to make a donation by significantly reducing the amount of time and computing resources otherwise required to make the donation, thereby providing an improvement over prior interactive video technique.

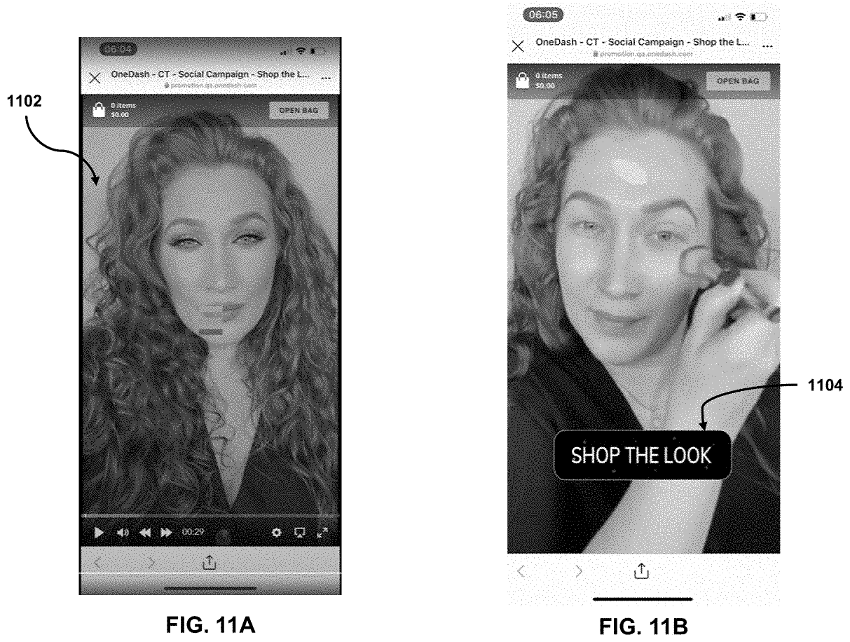

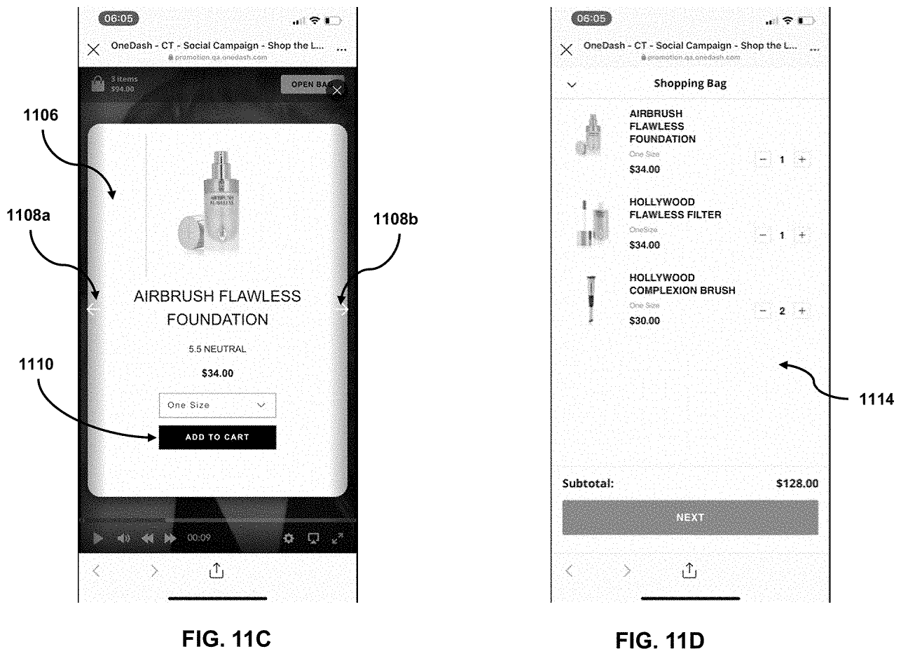

The interactive videos may be made for devices having different form factors. For example, the interactive videos may also be made for a mobile client device, such as a smartphone. FIGS. 11A-11D show interactive videos made for smartphones. FIG. 11A shows a screenshot of an interactive video 1102 made for a smartphone, in accordance with one or more embodiments. The video 1102 may be related to fashion products. FIG. 11B shows a screenshot of an interactive video with a hotspot, in accordance with one or more embodiments. Upon playing the video 1102, hotspot 1104 is presented, e.g., as an overlay on video 1102. In some embodiments, hotspot 1104 may be configured to present product information within video 1102 upon user selection of hotspot 1104, as illustrated in FIG. 11C. FIG. 11C shows a screenshot of an interactive video with product information, in accordance with one or more embodiments. Upon user selection of hotspot 1104, product information 1106 of a fashion product is presented within video 1102, e.g., as an overlay on video 1102. The user may customize the product by selecting one or more attributes (e.g., size) displayed in product information 1106. The user may access product information of additional products, if any, using GUI element 1108a or 1108b. The user may add the product to shopping cart, e.g., by selecting GUI element 1110. FIG. 11D shows a screenshot of an interactive video with shopping cart details, in accordance with one or more embodiments. The user may add products, e.g., from product information, to shopping cart 1114 without leaving, exiting, or otherwise being navigated away (e.g., to another website or application) from video 1102. The user may then proceed to complete the checkout process.

In some embodiments, the various computers and subsystems illustrated in FIG. 1 may include one or more computing devices that are programmed to perform the functions described herein. The computing devices may include one or more electronic storages, one or more physical processors programmed with one or more computer program instructions, and/or other components. The computing devices may include communication lines or ports to enable the exchange of information within a network or other computing platforms via wired or wireless techniques (e.g., Ethernet, fiber optics, coaxial cable, WiFi, Bluetooth, near field communication, or other technologies). The computing devices may include a plurality of hardware, software, and/or firmware components operating together. For example, the computing devices may be implemented by a cloud of computing platforms operating together as the computing devices.

The electronic storages may include non-transitory storage media that electronically stores information. The storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein of interactive content system 102 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 112-120 described herein is for illustrative purposes, and is not intended to be limiting, as any of subsystems 112-120 may provide more or less functionality than is described. For example, one or more of subsystems 112-120 may be eliminated, and some or all of its functionality may be provided by other ones of subsystems 112-120. As another example, additional subsystems may be programmed to perform some, or all of the functionality attributed herein to one of subsystems 112-120.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

What is claimed is:

1. A system for integrating a shopping cart into a video, the system comprising:
a computer system including one or more processors programmed with computer program instructions that, when executed, cause the computer system to:
obtain a video file, wherein the video file includes a video associated with a set of products among a plurality of products;
obtain access to an online store of a merchant hosted on a product server, wherein the access is obtained using an application programming interface associated with the online store, wherein the online store provides access to an inventory of the products;
obtain product information of the set of products from the inventory of the products, wherein the product information includes a subset of a plurality of attributes of each product from the set of products;
configure an interactive layer that, when interacted with by a user, provides access to the product information from within the video, wherein the interactive layer is configured to: in response to the video file being played, cause a hotspot of the interactive layer to be displayed as a first overlay on the video,
in response to receiving a user selection of the hotspot, cause the product information to be displayed as a second overlay on the video, wherein the user can access the product information within the second overlay, and
in response to receiving a user input for adding a specified product from the set of products to a shopping cart, add the specified product to the shopping cart within the second overlay; and generate a configuration file having the interactive layer for the video.

2. The system of claim 1, wherein the computer system is caused to:
in response to receiving a request from a client device to access the configuration file, play, using a player, the video with the interactive layer based on the configuration file;
receive, from the client device, a user input for adding the specified product to the shopping cart;
send, from the player, a verification request to the product server for verifying an availability of the specified product in the inventory of the products; and
add, by the player, the specified product to the shopping cart based on a response to the verification request from the product server indicating that the specified product is available.

3. The system of claim 1, wherein the computer system is caused to:
generate a link to the configuration file for being embedded in a webpage or an application.

4. A method implemented by one or more processors executing computer program instructions that, when executed, perform the method, the method comprising:
obtaining, at an interactive content system and from a product server, product information of a set of products, wherein the set of products are to be presented in a video to be played at a client device associated with a user, wherein the video is played using a player of the interactive content system;
configuring, by the interactive content system, an interactive layer for the video that provides user access to the product information from within the video, wherein the interactive layer is configured to:
present the product information in the player with the video, wherein the user can access the product information from within the video, and
add a specified product from the set of products to a shopping cart from within the video; and
generating a configuration file having the interactive layer for the video.

5. The method of claim 4, wherein configuring the interactive layer includes:
adding a hotspot to the video, wherein the hotspot is overlaid on the video as a first overlay, and wherein the hotspot is configured to provide access to the product information.

6. The method of claim 5, wherein adding the hotspot includes defining a location of the hotspot in the video, which indicates a position of the first overlay in the video.

7. The method of claim 5, wherein adding the hotspot includes defining a time of appearance of the hotspot, which indicates (a) a time of the video when the hotspot is configured to appear on the video, and (b) a duration for which the hotspot is configured to appear or a time of the video when the hotspot is configured to be removed from the video.

8. The method of claim 5, wherein adding the hotspot includes:
configuring the hotspot to provide access to product information of a first product of the set of products that is being displayed in the video at a time when a user selection of the hotspot is received.

9. The method of claim 5, wherein configuring the interactive layer includes:
adding the product information to the interactive layer; and
configuring the interactive layer to overlay the product information on the video as a second overlay different from the first overlay.

10. The method of claim 9, wherein configuring the interactive layer includes:
displaying the product information in the second overlay in response to a user selection of the hotspot.

11. The method of claim 10 further comprising:
configuring the interactive layer to add the specified product to the shopping cart within the second overlay.

12. The method of claim 4, wherein configuring the interactive layer includes:
configuring the player to receive product updates from the product server when the user interacts with the product information.

13. The method of claim 4, wherein obtaining the product information includes:
analyzing the video to obtain feature vectors representative of a first plurality of products in the video;
comparing the feature vectors representative of the first plurality of products to reference feature vectors representative of a second plurality of products stored in a storage system; and
identifying the set of products based on a result of the comparison.

14. The method of claim 4 further comprising:
receiving, from the client device, a request to access the configuration file; and
playing, by the player and at the client device, the video with the interactive layer, wherein the playing includes displaying a hotspot as a first overlay on the video, wherein the hotspot is configured to provide access to the product information.

15. The method of claim 14 further comprising:
receiving a user selection of the hotspot; and
in response to the receiving the user selection, displaying the product information on the video as a second overlay, wherein the user can access the product information within the second overlay.

16. The method of claim 15 further comprising:
receiving a user selection of the specified product; and
adding the specified product to the shopping cart within the second overlay.

17. The method of claim 4 further comprising:
receiving, from the client device, a request to access the configuration file; and
playing, by the player, the video with the interactive layer, wherein the playing includes displaying the set of products in a first portion of a player window that does not overlap with the video, wherein the player plays the video in the player window.

18. The method of claim 17 further comprising:
receiving a user selection of the specified product from the first portion; and
displaying the product information of the specified product in a second portion of the player window, wherein the user can access the product information of the set of products within the second portion.

19. The method of claim 18 further comprising:
receiving a user selection of the specified product in the second portion, the user selection for adding the specified product to the shopping cart; and
adding the specified product to the shopping cart from within the second portion.

20. The method of claim 4, wherein obtaining the product information includes:
obtaining, at the interactive content system, the product information using an application programming interface of the product server, wherein the product server hosts an online store having the set of products.

21. The method of claim 4, wherein generating the configuration file includes:
publishing, by the interactive content system, a link to the configuration file, which when accessed by the client device, causes the player to play the video at the client device by adding the interactive layer to the video.

22. The method of claim 4 further comprising:
in response to receiving a request from the client device to access the configuration file, playing, by the player, at the client device, the video with the interactive layer;
receiving, by the player, a user input to add the specified product to the shopping cart;
verifying, by the player, using an application programming interface associated with the product server, an availability of the specified product with the product server; and
adding, by the player, the specified product to the shopping cart based on the specified product being available.

23. The method of claim 4, wherein obtaining the product information includes:
obtaining a plurality of attributes of each product of the set of products from the product server.

24. A method implemented by one or more processors executing computer program instructions that, when executed, perform the method, the method comprising:
receiving a request from a client device to access a configuration file that enables a user to interact with a video, wherein video presents a set of products associated with an online store;
obtaining, from an interactive content system, the video based on the configuration file;
obtaining, from the interactive content system, an interactive layer based on the configuration file, wherein the interactive layer includes a hotspot that provides access to product information of the set of products from within the video; and
combining, by a player of the interactive content system, the video with the interactive player to play the video at the client device, wherein the combining includes:
overlaying the hotspot on the video as a first overlay, and
in response to user selection of the hotspot, overlaying the product information on the video as a second overlay, wherein the product information can be accessed within the second overlay.

25. The method of claim 24 further comprising:
receiving, by the player, a user selection of a specified product of a set of products in the second overlay; and
adding, by the player, the specified product to a shopping cart within the second overlay.

26. The method of claim 25, wherein adding the specified product to the shopping cart further includes:
sending, by the player, using an application programming interface associated with a product server, a verification request to verify an availability of the specified product in the online store, wherein the product server stores product information of a plurality of products associated with the online store; and
adding, by the player, the specified product to the shopping cart based on the response indicating that the specified product is available.

27. The method of claim 25 further comprising:
resuming, by the player, the video upon closing the second overlay.

28. The method of claim 25 further comprising:
sending, by the player, shopping cart information related to products added to the shopping cart to an interactive content system for generating analytical reports.

29. The method of claim 24 further comprising:
sending, by a product server that provides the product information of the set of products, order information to the interactive content system for generating analytical reports having information related to products transacted using the player.

30. A non-transitory computer-readable medium storing instructions that, when executed by one or more processors, cause operations comprising:
obtaining, from a product server, product information of a set of products to be displayed with a video to be played at a client device associated with a user;
configuring an interactive layer for the video that provides access to the product information from within a player configured to play the video, wherein configuring the interactive layer includes:
configuring the interactive layer to display the product information in the player, wherein the user can interact with the product information from within the video, and
configuring the interactive layer to add a specified product from the set of products to a shopping cart within the video; and
generating a configuration file having the interactive layer for the video.

31. The computer-readable medium of claim 30, wherein the operations comprise:
obtaining the product information using an application programming interface of the product server, wherein the product server hosts an online store having the set of products.

32. The computer-readable medium of claim 30, wherein the operations further comprise:
receiving, by the player, a user input to add the specified product to the shopping cart;
verifying, by the player, using an application programming interface associated with the product server, an availability of the specified product with the product server; and
adding, by the player, the specified product to the shopping cart based on the specified product being available.
